(19) United States
(12) Patent Application Publication
(10) Pub. No.: US 2004/0043123 A1
(43) Pub. Date: Mar. 4, 2004

(54) Refrigerable extended shelf-life liquid batter and method for its production

(76) Inventors: Angeliki Triantafyllou Oste, Lund (SE); Carina Andersson, Lund (SE); Rickard Oste, Lund (SE); Sofia Ehlde, Lund (SE)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/416,231

(22) PCT Filed: Nov. 9, 2001
(86) PCT No.: PCT/SE01/02479

(30) Foreign Application Priority Data
Nov. 10, 2000 (SE) 0004108-7

(51) Int. Cl. A21D 10/00

(52) U.S. Cl. 426/549

(57) ABSTRACT

A ready-to-use refrigerable liquid batter for preparing pancakes, waffles, brownies, muffins, cakes and the like comprises a starch component and an organic acid or a mixture of organic acids. The batter has been microbiologically stabilised by heating to a temperature below the gelatinisation temperature of the starch component for a time period sufficient to substantially reduce the bacterial count of the batter so as to make the batter storable for at least three weeks at a temperature of 8° C. or lower. Also disclosed is a process for preparing a batter of this kind.

### FIELD OF THE INVENTION

The present invention relates to a ready-to-use refrigerable liquid batter for preparing pancakes, waffles, brownies, muffins, cakes and the like, the batter having a shelf life adequate for commercial distribution and storage, and to a method for its production. “Refrigerable liquid batter” refers to a batter which is sufficiently liquid (pourable) at a temperature below 8° C. to permit its use at that temperature for making pancakes etc.

### BACKGROUND OF THE INVENTION

Pancakes, waffles, brownies, muffins, cakes and the like, that is are appreciated for composing main dishes and desserts. Typically pancakes etc. are made of egg, milk, fat and flour. However the variation of the ingredients is huge. The baked products have a high nutrient content, because they comprise substantial amounts of protein (e.g. milk and egg protein), fat and carbohydrate (e.g. starch), and they have a widely appealing taste. Cheese may be included in addition to or instead of milk and butter. Corn flour or cornstarch may substitute wheat flour and other starchy ingredients may be included such as oats, potato etc. The batter composition and flavour may thus vary to suit different purposes (e.g. main dish, dessert) and to meet the preference of different groups of people (e.g. kosher, ethnic, vegetarian).

By mixing of the fresh ingredients makes a pancake or waffle batter is produced. Alternatively a dry ingredient mix may be used to which a given amount of water is added. While a tasty product can be prepared from fresh ingredients by a person possessing the required skill and willing to spend the considerable time necessary, the use of a commercial dry ingredient mix shortens the time needed for preparation and requires little skill the result a product that is lacking some of the appeal and tastiness of the freshly prepared product. The obvious solution would be to provide a liquid batter which can be refrigerated, that is, kept at a temperature of from about 0° C. to about 8° C. To be commercially acceptable such refrigerated shelf-life batter would need to have a shelf life of a week or more, preferably of at least two weeks.

The reason for the inadequate shelf life of refrigerable batters known in the art is the poor microbiological status after storing the liquid mixture refrigerated for a couple of days. U.S. Pat. No. 4,353,932 discloses refrigerable pourable and stable pancake batters in which the water activity of the batter is below 0.95 to discourage the growth of microbiological organisms. The prior art batter has a relatively low total sugar content, contains obligatory effective amounts of a leavening agent, and has substantially neutral pH. While the batter of the '932 patent is said to be microbiologically stable over extended periods of time when kept in a refrigerator, no data indicating the level of stability are given.

A spoonable batter having a low water activity of about 0.81 to 0.92 is disclosed in WO 99/04640 to have a refrigerated shelf life of at least about 75 days. The water activity is controlled by the sugar component. The batter also comprises an obligatory shortening agent. The prior art batter has a viscosity between a that of a traditional pourable batter and a dough. Thus it is not freely pourable.

### OBJECTS OF THE INVENTION

It is an object of the invention to provide a refrigerable liquid batter of the aforementioned kind having a shelf life that is substantially extended in comparison with a freshly prepared state-of-the-art liquid batter.

It is another object of the invention to provide a process of manufacture for such batter.

Further objects of the invention will be evident from the following description of the invention and preferred embodiments thereof, as well as from the appended claims

### SUMMARY OF THE INVENTION

According to the present invention is disclosed a ready-to-use refrigerable liquid batter. Despite its high water content (A_{w}>0.95) the batter is microbiologically stable. The invention teaches the pasteurisation of a liquid batter for a time period sufficient to substantially lower the bacterial count and at a temperature below the gelatinisation temperature of the starch component of the batter. This treatment renders the product safe to store and use for several weeks, preferably for 12 weeks and more. In particular, according to the invention, thus is provided a ready-to-use refrigerable liquid batter having a water content (A_{w}) of 0.95 or higher and comprising a starch component of a kind that allowed the batter to be pasteurised at a temperature below the gelatinisation temperature of the starch component for a time period sufficient to make the batter display a total bacterial count of 1000 cfu/ml or less after storage for a period of 12 weeks at a temperature of from about 0° C. to about 8° C.

The obstacle to heat treatment (pasteurisation) is the gelatinisation of the starch used to prepare traditional batters. Ideally, gelatinisation should not occur or, at least, should not occur to an extent substantially affecting the pourability of the batter, until the batter is fried. When starch thickens prior to refrigeration the chilled batter is not pourable and its cooking properties are damaged. Wheat flour starch undergoes gelatinisation already at temperatures around 50° C. On the other hand pasteurisation of a batter at such a temperature does not yield an acceptable, that is, microbiologically safe, product.

Gelatinisation upon heating an aqueous starch suspension is dependent, i.a., on water activity, temperature and heating time. Water accessibility is prerequisite for the starch granules to undergo a transition from the micro-crystalline to the amorphous state with a concomitant increase in viscosity of the suspension. Gelatinisation occurs within a range of temperatures and can be monitored by a number of techniques. In the case of an excess of water being used, such as in the present invention, the temperature range of starch gelatinisation is characteristic for the origin of the starch and also depends on its purity. Thus the gelatinisation temperature (T_{g}) depends on whether the starch originates from e.g. potato, rice or wheat. A heterogeneous material undergoes gelatin sation within a broader temperature range than a pure material. Heating at high water content most efficiently decreases bacterial counts.

In this invention a starchy material of a high gelatinisation temperature is included in the batter, forming a gel only during cooking, thereby allowing pasteurisation of the batter. The starch material of the invention may be rice starch, rice flour, modified wheat or potato starch, annealed starch of various origin, waxy tapioca, amylomaize, waxy maize, arrowroot, and others. Thus, according to the present invention is provided a convenience refrigerated old-fashion batter made of milk, egg and vegetable or milk fat wherein the traditional wheat flour has been substituted by a starch material having a high gelatinisation temperature (T_{g}).

Furthermore, according to the present invention, is provided a refrigerated non-dairy batter comprising a milk alternative that can be used in the place of dairy milk, egg and vegetable fat in combination with the high T_{g} starch. The milk alternative may be a milky suspension made from a cereal, such as oats or rice (as the product of the U.S. Pat. No. 5,686,123 Lindahl et al.), or it may be soy drink, almond drink, etc.

According to the present invention is also provided a refrigerable liquid gluten-free batter comprising either dairy milk or an enzymatically hydrolysed starchy material free from gluten, such as oats, maize etc., egg, fat and the high T_{g} starch.

In particular, according to a first preferred aspect of the invention is provided a ready-to-use refrigerable liquid batter for preparing pancakes, waffles, brownies, muffins, cakes and the like, comprising a starch component and an organic acid or a mixture of organic acids, the batter having been microbiologically stabilised by heating to a temperature below the gelatinisation temperature of the starch component for a time period sufficient to substantially reduce the bacterial count of the batter so as to make the batter storable for at least three weeks at a temperature of 8° C. or lower.

It is preferred for the batter of the invention to have a water activity A_{w} greater than 0.90, preferably greater than 0.95.

It is also preferred that the batter of the invention has been stabilised microbiologically at a temperature from 60° C. to 72° C., in particular at a temperature of about 67° C.

A stabilisation period of from 2 to 10 minutes is preferred for the batter of the invention, in particular a stabilisation period of about 8 minutes.

The viscosity of the batter of the invention measured at 4° C. and 0.3 rpm is preferably from 5,000 cp to 60,000 cP, preferably of from 8,000 to 30,000 cP, in particular from 8,000 cp to 15,000 cP, most preferred about 10,000 cP.

The total bacterial count of the batter of the invention is preferably less than 1,000 cfu/ml upon storing at a temperature of 8° C. or lower for 12 weeks, in particular about 500 cfu/ml or less.

According to a second preferred aspect of the invention the batter comprises the organic acid or mixture of organic acids in an amount of from 0.05% by weight to 0.30% by weight, preferably of about 0.20% by weight.

According to a third preferred aspect of the invention, the organic acid or mixture of organic acids of the batter is selected from malic acid, sorbic acid including potassium sorbate, lactic acid, acetic acid, citric acid, tartaric acid, benzoic acid; particularly preferred is sorbic acid and malic acid; most preferred is a mixture of sorbic acid and malic acid.

According to a fourth preferred aspect of the invention the pH of the batter is adjusted to from 5.0 to 6.5 by said acid or mixture of acids, in particular to about 5.9.

The starch component of the butter is advantageously selected from rice starch, rice flour, modified wheat starch, modified potato starch, annealed starch of various origin, waxy tapioca, amylomaize, waxy maize, arrowroot.

According to fifth preferred aspect of the invention the batter is prepared from one member of the group consisting of oat base, UHT dairy milk, soy base, almond base, rice drink, dairy milk pasteurised at about 72° C.

According to a sixth preferred aspect of the invention is disclosed a pancake, waffle, brownie, muffin, cake and other fluffy baked product having a baked height to raw height of greater than about 1, prepared from the batter of the invention by optionally adding a leavening agent to the batter.

According to a seventh preferred aspect of the invention is disclosed a method of producing a ready-to-use refrigerable liquid batter for preparing pancakes, waffles, brownies, muffins, cakes and the like, comprising the following steps:

(a) providing, in a battering vessel, conventional batter ingredients comprising:

(1) cow milk or a cow milk substitute in an amount of from 40% by weight to 70% by weight, preferably about 62% by weight, having a total solids content of about 10%,

(2) optionally, homogenised whole eggs in an amount of from 10% by weight to 30% by weight, preferably about 20% by weight,

(3) a starch component having a gelatinisation temperature of more than 72° C. in an amount of 10-30% by weight, preferably of about 19% by weight,

(4) a food grade organic acid or a mixture of such acids in an amount of from 0.05% by weight to 0.30% by weight sufficient to adjust the pH of the batter to from 5.5 to 6.5, preferably to about 5.9;

(5) optionally potassium sorbate in an amount of 0% by weight to 0.25% by weight, preferably 0.15% by weight;

(b) battering the mixture of components (1)-(5) in the vessel for a time period sufficient to form a homogeneous liquid batter;

(c) heating the batter to a temperature of from 60° C. to 72° C. for a time sufficient to substantially reduce the bacterial count of the batter;

(d) cooling the batter to a temperature of 8° C. or lower but not low enough to make the water in the batter freeze;

(e) packaging aseptically portions of the batter for distribution and storage at said temperature.

Conventional batter ingredients include but are not limited to: fat, such as corn oil, safflower oil, soybeen oil, butter, margarine, lard; egg substitutes, such as egg solids; nonfat dry milk; fruit bits, such as raisins, hazelnuts; sweeteners, such as sucrose, glucose, dextrose, corn syrup, fructose dextrose syrup, lactose; leavening agents; emulsifiers, such as mono- and diglycerides of fatty acids, higher fatty acid esters of sugars and sugar alcohols; flavour, such as vanilla; sea salt.

It is preferred to use, in the process of the invention, as cow milk a dairy milk treated with a Ultra High Temperature (UHT) method or a conventionally pasteurised dairy milk.

It is also preferred to use, in the process of the invention, as cow milk substitute one of: oat base, rice milk, soy base, almond base.

It is furthermore preferred to use, in the process of the invention, a starch component selected from rice starch, rice flour, modified wheat starch, modified potato starch, annealed starch of various origin, waxy tapioca, amylomaize, waxy maize, arrowroot.

In addition it is preferred to use, in the process of the invention, an acid or mixture of acids selected from malic acid, lactic acid, acetic acid, citric acid, tartaric acid, benzoic acid, sorbic acid.

### DESCRIPTION OF PREFERRED EMBODIMENTS

General description of the batter of the invention set out in detail in the following EXAMPLES. The liquid refrigerable batter has a water activity A_{w} of around 0.98. It comprises essentially milk (or a milk substitute), eggs, a starchy material (starch or flour) with a high gelatinisation temperature (T_{g}) and a preservative such as an organic acid, preferably malic acid, and/or potassium sorbate. The batter is pasteurised at 60-72° C. for a period of 2-10 min, preferably at 67° C. for 8 minutes. Then batter is cooled rapidly to a temperature of 8° C. or lower and packed aseptically. The viscosity of the batter at 4° C. and 0.3 rpm is about 10,000 cP, similar to the viscosity of a conventional batter. The batter may be used for preparing pancakes, waffles or the like. The taste and consistency of these products resembles that of their traditional counterparts. Pasteurisation lowers microbial counts to a level rendering the product safe to consume for at least 10 weeks when kept at a temperature of 8° C. or lower. Thus the product of the invention may be safely distributed and stored before being used to prepare pancakes and waffles. Current Swedish maximum acceptable microbial contamination values for food intended for human consumption are as follows:

Total number of microorganisms 10⁷ cfu;

Bacillus cereus 10⁴ cfu;

Yeast 10⁴ cfu;

Moulds 10³ cfu.

### EXAMPLE 1

Pancake Batter Prepared from UHT Dairy Milk.

Constituents:

1) Cow milk 40-70% by weight, preferably 62% by weight, having a fat content of around 1.5% and a total solids content of about 10%. The milk had been treated with Ultra High Temperature (UHT) method at 142° C. for 4 sec;

2) Eggs 10-30% by weight, preferably 20% by weight, of homogenised whole eggs;

3) Rice starch in an amount of 10-30% by weight, preferably 19% by weight (Remy B7, from Remy Industries, Leuven, Belgium);

4) Salt (sodium chloride) in an amount of 0-0.7% by weight, preferably 0.5% by weight;

5) A food grade organic acid or a mixture of such acids in an amount of 0.05-0.30% by weight, such as malic, lactic, acetic, citric acid, to adjust the pH at about 5.5 to about 6.5; preferably malic acid 0.1% by weight of malic acid to obtain a pH 5.9;

6) Optionally, potassium sorbate in an amount of 0-0.25% by weight, preferably 0.15% by weight;

7) Flavours may optionally be added, such as vanilla, cumin, cheese favour, etc.

The ingredients are thoroughly mixed to form a batter. The batter is pasteurised at 60-72° C., preferably at about 67° C., for 2-10 minutes, preferably about 8 minutes. The product is cooled to a temperature of 8° C. or lower but not to a temperature at which it begins to freeze, and stored at that temperature to prevent microbial growth.

Microbiological status:

Prior to pasteurisation

Total count: 360 cfu/ml (colony forming units per ml) of batter;

Bacillus cereus: <10 cfu/ml;

Yeast and moulds: 20 cfu/ml.

Directly after pasteurisation for 8 minutes at 67° C.

Total count: 150 cfu/ml with malic acid only or 80 cfu/ml with both malic acid and sorbate;

Bacillus cereus <10 cfu/ml;

Yeast and moulds: 1 cfu/ml.

After storing the pasteurised product at 8° C.

a) With both malic acid and sorbate; 12 weeks' storage

Total count: 130 cfu/ml;

Bacillus cereus 20 cfu/ml.

b) With malic acid only; 6 weeks' storage

Total count: 500 cfu/ml;

Bacillus cereus 400 cfu/ml.

### EXAMPLE 2

Pancake Batter Prepared from an Oat Base.

Oat drink UHT treated with total solids content of 10% by weight is used instead of the cow milk of Example 1; otherwise, the procedure of EXAMPLE 1 is followed. A commercial oat base product of the Lindahl et al. or oat-based milk alternatives like Adavena© M40 (Ceba AB, Sweden) may be employed. The fat content of the oat base is adjusted to a total fat content of 1.5% by the addition of a vegetable oil such as rape seed, sunflower, safflower, maize, olive oil; preferably rape seed oil is used. Calcium is added to the oat base as tricalcium phosphate in an amount of about 0.1% by weight to increase the nutritional value of the batter. This batter may be used also by people who avoid milk due to lactose intolerance, people that are allergic to milk protein and people on a kosher diet.

Microbiological status

Prior to pasteurisation

Total count: 350 cfu/ml of batter;

Bacillus cereus <10 cfu/ml;

Yeast and moulds 50 cfu/ml.

Directly after pasteurisation at 67° C. for 8 minutes

Total count: 150 cfu/ ml with malic acid only or 80 cfu/ml with both acid and sorbate;

Bacillus cereus <10 cfu/ml;

Yeast and moulds 2 cfu/nl.

After storing the pasteurised product for at 8° C.

a) With both malic acid and sorbate; 12 weeks' storage

Total count: 190 cfu/ml;

Bacillus cereus 20 cfu/ml.

b) With malic acid only; 6 weeks' storage

Total count: 500 cfu/ml;

Bacillus cereus 350 cfu/ml.

### EXAMPLE 3

Pancake Batter Prepared from a Soy or Almond Base.

Soy drink or almond drink UHT substitutes the cow milk in EXAMPLE 1; otherwise, the procedure of EXAMPLE 1 is followed. If a soy base is used sugar may be added to obtain browning upon heating the batter. The absence of reducing sugars in soy drink will otherwise produce an only lightly coloured pancake whereas the lactose and maltose of dairy milk and oat drink, respectively, will promote the formation of coloured Maillard products. A liquid pancake batter storable for 10 weeks at a temperature of 8° C. or lower is obtained.

### EXAMPLE 4

Pancake Batter Prepared from Rice Drink.

The dairy milk of EXAMPLE 1 is exchanged for rice drink, the preparation of the batter otherwise being unchanged. A liquid pancake batter storable for 10 weeks at a temperature of 8° C. or lower is obtained.

### EXAMPLE 5

Pancake Batter Prepared from Pasteurised Dairy Milk.

The sterilised or high-temperature pasteurised cow milk of EXAMPLE 1 is substituted by dairy milk pasteurised at 72° C. for 15 sec thereby having a higher total microbial count than UHT milk; otherwise, the procedure of EXAMPLE 1 is followed. A liquid pancake batter storable for a shorter period of time than the batters of EXAMPLES 1-4 is obtained.

Microbiological status:

Prior to pasteurisation

Total count: 9,000 cfu/ml of batter;

Bacillus cereus <10 cfu/ml;

Yeast and moulds 20 cfu/ml.

Directly after pasteurisation at 67° C. for 8 minutes

Total count: 7,000 cfu/ ml with malic acid only or 80 cfu/ml with both acid and sorbate;

Bacillus cereus 100 cfu/ml;

Yeast and moulds 1 cfu/ml.

After storing the pasteurised product for at 8° C.

a) With both malic acid and sorbate; 12 weeks' storage

Total count: 130 cfu/ml;

Bacillus cereus 20 cfu/ml.

b) With malic acid only; 6 weeks' storage

Total count: 5,500 cfu/ml;

Bacillus cereus 20 cfu/ml.

1. Ready-to-use refrigerable liquid batter for preparing pancakes, waffles, brownies, muffins, cakes and the like, comprising a starch component and an organic acid or a mixture of organic acids, characterised in that it has been microbiologically stabilised by heating to a temperature below the gelatinisation temperature of the starch component for a time period sufficient to substantially reduce the bacterial count of the batter so as to make the batter storable for at least three weeks at a temperature of 8° C. or lower.

2. The batter of claim 1, characterised by a water activity A_{w} greater than 0.90.

3. The batter of claim 2, characterised by a water activity A_{w} greater than 0.95.

4. The batter of claim 1, characterised by having been stabilised microbiologically at a temperature from 60° C. to 72° C.

5. The batter of claim 4, characterised by having been stabilised microbiologically at a temperature of about 67° C.

6. The batter of claim 1, characterised by a stabilisation period of from 2 to 10 minutes.

7. The batter of claim 6, characterised by a stabilisation period of about 8 minutes.

8. The batter of claim 1, characterised by a viscosity at 4° C. and 0.3 rpm of from 5,000 cp to 60,000 cP, preferably of from 8,000 to 30,000 cP, in particular from 8,000 cp to 15,000 cP.

9. The batter of claim 8, characterised by a viscosity at 4° C. and 0.3 rpm of about 10,000 cP.

10. The batter of claim 1, characterised by a total bacterial count of less than 1,000 cfu/ml upon storing at a temperature of 8° C. or lower for 12 weeks.

11. The batter of claim 10, characterised by a total bacterial count of about 500 cfu/ml or less upon storing at a temperature of 8° C. or lower for 12 weeks.

12. The batter of claim 1, wherein the organic acid or mixture of organic acids is present in an amount of from 0.05% by weight to 0.30% by weight.

13. The batter of claim 1, wherein the organic acid or mixture of organic acids is selected from malic acid, sorbic acid including potassium sorbate, lactic acid, acetic acid, citric acid, tartaric acid, benzoic acid.

14. The batter of claim 1, wherein the pH is adjusted to from 5.0 to 6.5 by said acid or mixture of acids.

15. The batter of claim 14, wherein the pH is about 5.9.

16. The batter of claim 1, wherein the starch component is selected from rice starch, rice flour, modified wheat starch, modified potato starch, annealed starch of various origin, waxy tapioca, amylomaize, waxy maize, arrowroot.

17. The batter of claim 1 prepared from an oat base.

18. The batter of claim 1 prepared from UHT dairy milk.

19. The batter of claim 1 prepared from a soy or almond base.

20. The batter of claim 1 prepared from a rice drink.

21. The batter of claim 1 prepared from dairy milk pasteurised at about 72° C.

22. A pancake, waffle, brownie, muffin, cake and other fluffy baked product having a baked height to raw height of greater than about 1, prepared from the batter of any of claims 1-21.

23. A method of producing a ready-to-use refrigerable liquid batter for preparing pancakes, waffles, brownies, muffins, cakes and the like, comprising the following steps:
(a) providing, in a battering vessel, conventional batter ingredients comprising
(1) cow milk or a cow milk substitute in an amount of from 40% by weight to 70% by weight, preferably about 62% by weight, having a total solids content of about 10%,
(2) optionally, homogenised whole eggs in an amount of from 10% by weight to 30% by weight, preferably about 20% by weight,
(3) a starch component having a gelatinisation temperature of more than 72° C. in an amount of 10-30% by weight, preferably of about 19% by weight,
(4) a food grade organic acid or a mixture of such acids in an amount of from 0.05% by weight to 0.30% by weight sufficient to adjust the pH of the batter to from 5.5 to 6.5, preferably to about 5.9;
(5) optionally potassium sorbate in an amount of 0% by weight to 0.25% by weight, preferably 0.15% by weight;
(b) battering the mixture of components (1)-(5) in the vessel for a time period sufficient to form a homogeneous liquid batter;
(c) heating the batter to a temperature of from 60° C. to 72° C. for a time sufficient to substantial reduce the bacterial count of the batter;
(d) cooling the batter to a temperature of 8° C. or lower but not low enough to make the water in the batter freeze;
(e) packaging aseptically portions of the batter for distribution and storage at said temperature.

24. The process of claim 23, wherein the cow milk is a dairy milk treated with a Ultra High Temperature (UHT) method.

25. The process of claim 23, wherein the cow milk is a conventionally pasteurized dairy milk.

26. The process of claim 23, wherein the cow milk substitute is an oat base.

27. The process of claim 23, wherein the cow milk substitute is rice milk.

28. The process of claim 23, wherein the cow milk substitute is a soy or almond base.

29. The process of claim 23, wherein the starch component is selected from rice starch, rice flour, modified wheat starch, modified potato starch, annealed starch of various origin, waxy tapioca, amylomaize, waxy maize, arrowroot.

30. The process of claim 23, wherein the acid or mixture of acids is selected from malic acid, lactic acid, acetic acid, citric acid, tartaric acid, benzoic acid, sorbic acid.

31. A ready-to-use refrigerable liquid batter having a water content (A_{w}) of 0.95 or higher, comprising a starch component of a kind that allowed the batter to be pasteurised at a temperature below the gelatinisation temperature of the starch component for a time period sufficient to make the batter display a total bacterial count of 1000 cfu/ml or less after storage for a period of 12 weeks at a temperature of from about 0° C. to about 8° C.

32. The batter of claim 31, wherein the starch component is selected from rice starch, rice flour, modified wheat or potato starch, annealed starch of various origin, waxy tapioca, amylomaize, waxy maize, arrowroot, and others.

33. The batter of claim 31, wherein said bacterial count is 500 cfu/ml or less.

34. The batter of claim 31, wherein said storage temperature is about 8° C.
